(19) United States
(12) Patent Application Publication
(10) Pub. No.: US 2014/0282226 A1
(43) Pub. Date: Sep. 18, 2014

(54) Electronic Apparatus, Display Control Method and Storage Medium

(71) Applicant: Kabushiki Kaisha Toshiba, Tokyo (JP)

(72) Inventor: Yosuke Takahashi, Kobubunji-shi (JP)

(73) Assignee: Kabushiki Kaisha Toshiba, Tokyo (JP)

(21) Appl. No.: 14/280,231

(22) Filed: May 16, 2014

Related U.S. Application Data
(63) Continuation of application No. PCT/JP2013/057705, filed on Mar. 18, 2013.

(51) Int. Cl. G06F 3/0485; G06F 3/0481; G06F 3/0488

(52) U.S. Cl. CPC G06F 3/0485; G06F 3/0488; G06F 3/0481
USPC 715/784

(57) ABSTRACT

According to one embodiment, an electronic apparatus includes a display processor and a controller. The display processor is configured to display a first area corresponding to at least part of a display object on a screen in accordance with a display magnification. The first area is movable in accordance with a scroll operation within an area of the display object. The controller is configured to enlarge a display magnification if a scrolling speed of the first area exceeds a first value beyond a first period, and not to enlarge a display magnification if a period in which the scrolling speed of the first area exceeds the first value is shorter than the first period.

### CROSS-REFERENCE TO RELATED APPLICATIONS

This application is a Continuation Application of PCT Application No. PCT/JP2013/057705, filed Mar. 18, 2013, the entire contents of which are incorporated herein by reference.

### FIELD

Embodiments described herein relate generally to a display control technique of an electronic apparatus including a scrolling function.

### BACKGROUND

In recent years, various electronic apparatuses which can be driven by a battery and easily carried, such as a tablet terminal and a smartphone, have been developed. These types of electronic apparatuses mostly include a touch screen display in order for a user to easily conduct input operations.

By touching a menu or an object displayed on a touch screen display with a finger, etc., a user can instruct an electronic apparatus to execute a function associated with the menu or the object. A user can conduct not only a touch relative to a menu or an object but also so-called scrolling that moves a display range to, for example, the left, right, top and bottom, by a touch operation on the touch screen display. Various idea related to display processes on a screen including a touch screen display have been made.

For example, when information is displayed in a window whose size is fixed, and the information volume is huge, sometimes a certain area is clipped out from the whole information, and this area is enlarged to be displayed. For example, there is a case where a part of an image is enlarged to be displayed, or only a part of a list including enormous items is displayed in a window. With respect to an area drawn in a window (a display area or a display range), an apparatus or a program including the above function includes a function of moving (scrolling) a display area in the whole information by a user operation.

Here, a case where a scrolling speed is accelerated is assumed. In this case, even if information which is valuable to a user is displayed within a display area, there is a possibility that the information goes out of the display area before the information is recognized by the user. Thus, the user might overlook the information.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective illustration showing an appearance of an electronic apparatus according to an embodiment.

FIG. 2 is an exemplary diagram showing a system structure of the electronic apparatus according to the embodiment.

FIG. 3 is an exemplary flowchart showing operation procedures relating to scrolling of the electronic apparatus according to the embodiment.

FIG. 4 is an exemplary diagram showing an example of scrolling of the electronic apparatus according to the embodiment.

### DETAILED DESCRIPTION

Various embodiments will be described hereinafter with reference to the accompanying drawings.

In general, according to one embodiment, an electronic apparatus includes a display processor and a controller. The display processor is configured to display a first area corresponding to at least part of a display object on a screen in accordance with a display magnification. The first area is movable in accordance with a scroll operation within an area of the display object. The controller is configured to enlarge a display magnification if a scrolling speed of the first area exceeds a first value beyond a first period, and not to enlarge a display magnification if a period in which the scrolling speed of the first area exceeds the first value is shorter than the first period.

An electronic apparatus of the present embodiment may be realized as a portable electronic apparatus which enables touch input with a finger, such as a tablet terminal and a smartphone. FIG. 1 is an exemplary perspective illustration showing the appearance of the electronic apparatus according to the present embodiment. As shown in FIG. 1, here, a case where the electronic apparatus is realized as a tablet terminal 10 is assumed. The tablet terminal 10 includes a main body 11 and a touch screen display 12. The touch screen display 12 is attached so as to overlap the upper surface of the main body 11.

The main body 11 includes a housing having the form of a thin box. A flat panel display, and a sensor configured to detect the contact position of a finger on the screen of the flat panel display are incorporated into the touch screen display 12. The flat panel display is, for example, a liquid crystal display (LCD) device. The sensor is, for example, a capacitance type of touch panel.

FIG. 2 is an exemplary diagram showing a system structure of the tablet terminal 10.

The tablet terminal 10 includes, as shown in FIG. 2, a CPU 101, a system controller 102, a main memory 103, a graphics controller 104, a BIOS-ROM 105, a nonvolatile memory 106, a wireless communication device 107 and an embedded controller (EC) 108, etc.

The CPU 101 is a processor that controls an operation of each module within the tablet terminal 10. The CPU 101 executes various types of software loaded from the nonvolatile memory 106 into the main memory 103. The software includes an operating system (OS) 201 and various types of application programs 202. The OS 201 includes a scrolling controller 301 described later.

The CPU 101 also executes a basic input/output system (BIOS) stored in the BIOS-ROM 105. The BIOS is a program for hardware control.

The system controller 102 is a device that connects a local bus of the CPU 101 and various components. A memory controller that conducts access control of the main memory 103 is also housed in the system controller 102. The system controller 102 also includes a function of communicating with the graphics controller 104 via a serial bus of PCI EXPRESS standard, etc.

The graphics controller 104 is a display controller that controls an LCD 12A used as a display monitor of the tablet terminal 10. A display signal generated by the graphics controller 104 is sent to the LCD 12A. The LCD 12A displays a screen image based on the display signal. A touch panel 12B is provided on the LCD 12A. The touch panel 12B is, for example, a capacitance type of pointing device for conducting input on the screen of the LCD 12A. The position of contact of a finger on the screen is detected by the touch panel 12B.

The wireless communication device 107 is a device configured to conduct wireless communication such as a wireless LAN and 3G mobile communications. The EC 108 is a single-chip microcomputer containing an embedded controller for power management. The EC 108 includes a function of turning the tablet terminal 10 on/off in accordance with a power button operation by a user.

Next, this specification explains operations relating to scrolling of the tablet terminal 10 having the above structures.

The scrolling in the tablet terminal 10 is controlled by the scrolling controller 301 of the OS 201. If a display area is detected as moving at high speed, the scrolling controller 301 automatically enlarges the display area. This prevents a user from overlooking information. Further, when the moving speed of the display area becomes slow, the scrolling controller 301 changes the size of the display area back to the original one.

FIG. 3 is an exemplary flowchart showing operation procedures relating to scrolling of the tablet terminal 10.

The scrolling controller 301 firstly detects the start of scrolling (block A1). A mechanism used for detection is related to an operation interface by a user, and monitors a user operation initiating scrolling, such as a flick operation and hold-down of a scrolling button. A flick operation is an operation which can be input by, for example, the move of a contact position with a finger at a speed above a certain level, and the disappearance of the contact with the finger afterward (that is, the removal of the finger from the touch screen display 12).

Upon the start of scrolling is detected (YES in block A1), the scrolling controller 301 determines whether or not the scrolling is still in progress (block A2). This determination depends on whether or not the position of a display area relative to the whole information is changed after a certain period. For example, in a case where a display area is rectangular, the scrolling controller 301 stores a coordinate of the upper left end of the display area at regular time intervals, and compares coordinates at the same point with each other after a certain period in order to check whether or not the value is changed. If the value is changed, the scrolling controller 301 determines that the scrolling still continues.

If the scrolling controller 301 determines that the scrolling still continues (YES in block A2), the scrolling controller 301 calculates the speed from the movement distance of the display area (block A3). In the previous example, when the change amount of coordinates of the upper left end of the rectangular area relative to the whole information is Δv, and the measured interval of coordinates is Δt, the speed v is Δy/Δt.

Moreover, the scrolling controller 301 determines whether or not the display area is enlarged during scrolling (block A4). The scrolling controller 301 stores information regarding whether or not the display area is enlarged. Hereinafter this state is referred to as a scrolling mode. In the scrolling mode, there are two types. One of them is normal scrolling that does not enlarge a display area. The other one is zoom-out scrolling that enlarges a display area.

Here, a threshold value of speed for switching the scrolling mode between normal scrolling and zoom-out scrolling is defined as V. V is assumed to be a fixed value, and be set in advance. However, V may be freely changed by the user. When the operation is conducted with normal scrolling at present (NO in block A4), and the relationship is v>V (YES in block A5), the scrolling controller 301 switches the scrolling mode to zoom-out scrolling (block A6). On the other hand, when the present operation is conducted with zoom-out scrolling (YES in block A4), and the relationship is v<=V (YES in block A7), the scrolling controller 301 switches the scrolling mode to normal scrolling (block A8).

In switching the scrolling mode (blocks A6 and A8), a scaling process of a display area is conducted. For example, the scrolling controller 301 enlarges or shrinks a two-dimensional direction by a certain amount based on a point which is the center of the display area. When the scrolling mode is switched, the scrolling speed does not change. In sum, the scrolling controller 301 equalizes the movement amount of the display area relative to the whole information within a certain period to the value before the scrolling mode is changed. Thus, when the speed is the same, the display time of an arbitrary area in the whole information in zoom-out scrolling is longer than normal scrolling. Therefore, a user is difficult to miss out information.

FIG. 4 illustrates an example of scrolling by the tablet terminal 10.

In FIG. 4, the upper stage (A) shows the whole information (a) of a display object. In this example, the whole information (a) is the entire image. The area shown by dashed lines is a display area (b), and is enlarged and displayed as information displayed in a window (c1, c2, . . . ) in the lower stage (B).

[1] is a state right after a user starts a scrolling operation. The area (b) shown by dashed lines is enlarged and displayed in the window.

[2] is a state at which the scrolling operation is conducted but the speed (v) does not exceed the threshold V. The coordinate moves with the size of the display area (b) unchanged.

[3] is a state at which the mode is changed to zoom-out scrolling since the scrolling speed exceeds V. The display area (b) is enlarged, and a wider area is displayed in the window.

[4] is a state at which the display area (b) is moved with the area enlarged by zoom-out scrolling.

[5] is a state at which the mode is changed back to normal scrolling since the speed is V or less. The display area (b) is shrunk, and the area whose size is the same as the size before switching the scrolling mode is displayed.

Thus, according to the tablet terminal 10, when the movement speed of a display area is fast, by automatically enlarging the size of the display area, it is possible to prevent a user from overlooking information without extra operations.

As described above, the tablet terminal 10 switches the scrolling mode from normal scrolling to zoom-out scrolling when the scrolling speed (v) exceeds the threshold (V). Further, the tablet terminal 10 switches the scrolling mode from zoom-out scrolling to normal scrolling when the scrolling speed (v) is the threshold (V) or less. A grace time for switch may be set with respect to the switch between normal scrolling and zoom-out scrolling.

Specifically, for example, when the mode is zoom-out scrolling, and the period in which the scrolling speed (v) is less than or equal to the threshold (V) is less than or equal to the first period, the mode is not changed to normal scrolling, and is maintained as zoom-out scrolling (the display range is not narrowed). For example, when the mode is normal scrolling, and the period in which the scrolling speed (v) exceeds the threshold (V) is less than or equal to the second period, the mode is not changed to zoom-out scrolling, and is maintained as normal scrolling (the display range is not enlarged).

By the above configuration, it is possible to deal with a non-uniform scrolling speed which is caused when a user flicks or drags a screen.

For example, when a user wants to further laterally scroll a screen, the user continuously flicks the screen. However, at the moment the screen is touched for flick, scrolling may be stopped for a moment, and the scrolling speed (v) may be measured as zero. If the display range is changed only at that moment, the screen is difficult to be seen as the screen flickers.

Similarly, for example, at the moment a user rapidly scrolls a screen by accident although the user wants to slowly scroll the screen in a lateral direction, the scrolling speed (v) may exceed the threshold (V). If the display range is changed only at that moment, the screen is difficult to be seen as the screen flickers.

This kind of problem can be dealt with by setting a grace time for switch with respect to the switch between normal scrolling and zoom-out scrolling.

As described above, the tablet terminal 10 realizes display control for reducing the chances of overlooking information at the time of scrolling.

All of the operation procedures of the present embodiment can be realized by software. Therefore, by introducing this software into a normal computer through a computer-readable storage medium, the same effect as the present embodiment can be easily obtained.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a display processor configured to display a first area corresponding to at least part of a display object on a screen in accordance with a display magnification, wherein the first area is movable in accordance with a scroll operation within an area of the display object; and
a controller configured to enlarge a display magnification if a scrolling speed of the first area exceeds a first value beyond a first period, and not to enlarge a display magnification if a period in which the scrolling speed of the first area exceeds the first value is shorter than the first period.

2. The apparatus of claim 1, wherein the controller is configured to change the display magnification back to the display magnification before the first area is enlarged, if the scrolling speed of the first area is less than or equal to the first value, or less than or equal to a value in which a margin is set in the first value, after the display magnification is enlarged.

3. The apparatus of claim 2, wherein the controller is configured not to change the display magnification back to the display magnification before the first area is enlarged, if the scrolling speed of the first area is less than or equal to the first value, or less than or equal to the value in which the margin is set in the first value, after the display magnification is enlarged, and if a period in which the scrolling speed of the first area is less than or equal to the first value, or less than or equal to the value in which the margin is set in the first value is less than or equal to a first period.

4. The apparatus of claim 1, wherein the controller is configured to further enlarge the display magnification if the scrolling speed of the first area exceeds a second value which is larger than the first value.

5. The apparatus of claim 1, further comprising a touch screen display,
wherein the display processor is configured to execute movement of the first area, if a first touch operation is conducted on the touch screen display.

6. The apparatus of claim 5, wherein the first touch operation comprises a flick operation which is allowed to be detected by movement of a position of contact of the touch screen display with an object at a first speed or higher, and disappearance of the contact of the touch screen display with the object.

7. The apparatus of claim 1, further comprising an operation module,
wherein the display processor is configured to execute movement of the first area, if an operation for scrolling the first area is conducted by the operation module.

8. A display control method of an electronic apparatus, the method comprising:
displaying a first area corresponding to at least part of a display object on a screen in accordance with a display magnification, wherein the first area is movable in accordance with a scroll operation within an area of the display object; and
enlarging a display magnification if a scrolling speed of the first area exceeds a first value beyond a first period, and not enlarging a display magnification if a period in which the scrolling speed of the first area exceeds the first value is shorter than the first period.

9. The method of claim 8, wherein the enlarging comprises changing the display magnification back to the display magnification before the first area is enlarged, if the scrolling speed of the first area is less than or equal to the first value, or less than or equal to a value in which a margin is set in the first value, after the display magnification is enlarged.

10. The method of claim 9, wherein the enlarging comprises unchanging the display magnification back to the display magnification before the first area is enlarged, if the scrolling speed of the first area is less than or equal to the first value, or less than or equal to the value in which the margin is set in the first value, after the display magnification is enlarged, and if a period in which the scrolling speed of the first area is less than or equal to the first value, or less than or equal to the value in which the margin is set in the first value is less than or equal to a first period.

11. The method of claim 8, wherein the enlarging comprises further enlarging the display magnification if the scrolling speed of the first area exceeds a second value which is larger than the first value.

12. The method of claim 8, further comprising executing movement of the first area, if a first touch operation is conducted on a touch screen display.

13. The method of claim 12, wherein the first touch operation comprises a flick operation which is allowed to be detected by movement of a position of contact of the touch screen display with an object at a first speed or higher, and disappearance of the contact of the touch screen display with the object.

14. The method of claim 8, further comprising executing movement of the first area, if an operation for scrolling the first area is conducted by an operation module.

15. A computer-readable, non-transitory storage medium having stored thereon a computer program which is executable by a computer, the computer program controlling the computer to function as:
a display processor configured to display a first area corresponding to at least part of a display object on a screen in accordance with a display magnification, wherein the first area is movable in accordance with a scroll operation within an area of the display object; and
a controller configured to enlarge a display magnification if a scrolling speed of the first area exceeds a first value beyond a first period, and not to enlarge a display magnification if a period in which the scrolling speed of the first area exceeds the first value is shorter than the first period.

16. The medium of claim 15, wherein the controller is configured to change the display magnification back to the display magnification before the first area is enlarged, if the scrolling speed of the first area is less than or equal to the first value, or less than or equal to a value in which a margin is set in the first value, after the display magnification is enlarged.

17. The medium of claim 16, wherein the controller is configured not to change the display magnification back to the display magnification before the first area is enlarged, if the scrolling speed of the first area is less than or equal to the first value, or less than or equal to the value in which the margin is set in the first value, after the display magnification is enlarged, and if a period in which the scrolling speed of the first area is less than or equal to the first value, or less than or equal to the value in which the margin is set in the first value is less than or equal to a first period.

18. The medium of claim 15, wherein the controller is configured to further enlarge the display magnification if the scrolling speed of the first area exceeds a second value which is larger than the first value.

19. The medium of claim 15, wherein the display processor is configured to execute movement of the first area, if a first touch operation is conducted on a touch screen display.

20. The medium of claim 19, wherein the first touch operation comprises a flick operation which is allowed to be detected by movement of a position of contact of the touch screen display with an object at a first speed or higher, and disappearance of the contact of the touch screen display with the object.

21. The medium of claim 15, wherein the display processor is configured to execute movement of the first area, if an operation for scrolling the first area is conducted by an operation module.
